(19) United States
(12) Patent Application Publication
(10) Pub. No.: US 2010/0055650 A1
(43) Pub. Date: Mar. 4, 2010

(54) Teaching model, method of use, and a kit therefor

(76) Inventor: Jennifer Bridges, Midland, MI (US)

Correspondence Address: MCKELLAR IP LAW, PLLC, 784 SOUTH POSEYVILLE ROAD, MIDLAND, MI, 48640, US

(21) Appl. No.: 12/231,431

(22) Filed: Sep. 3, 2008

(51) Int. Cl. G09B 11/00; G09B 23/28; G09B 19/00; G09B 23/00

(52) U.S. Cl. 434/84; 434/267; 434/247; 434/276

(57) ABSTRACT

Teaching models that use luminescent paint to paint inscriptions on the surface of the model which can be read by using black light. By use of the model so modified, the model can be used as a teaching tool in an educational instruction method in which the kinesthetic multiple intelligence of the student is enhanced since the student is in control of the timing of the feedback from the model.

This invention deals with a new and novel teaching model that uses luminescent paint to paint inscriptions on the surface of the model which can be read by using black light. By use of the model so modified, the model can be used as a teaching tool in an educational instruction method in which the kinesthetic multiple intelligence of the student is enhanced since the student is in control of the timing of the feedback from the model.

### BACKGROUND OF THE INVENTION

The inventor herein is unaware of any publication that deals with the subject matter of this invention.

It is well-known to educational consultants and others that work in the class room is amplified if there is a working model used by the students and as a consequence, there is a rather large commercial business in manufacturing and supplying models for surgical activities, nursing activities, and other similar instructional activities.

The essence of this invention is a model that can be used for instructional purposes in which the unique instructional method enhances the student's kinesthetic multiple intelligence, with the addition of delayed visual feedback, that is augmented by the use of the black light on luminescent paint. The student is in control of the timing of the feedback, which is an important learning variable involved in achieving maximal enhancement of any learning process.

### SUMMARY OF THE INVENTION

The instant invention deals, in one embodiment, with a technical process that is the use of luminescent paint that is not visible in natural light, but is visible using a black light, to paint inscriptions on models for educational purposes. The invention puts important written or symbolic content on models, such as for example, anatomical models, using luminescent paint. The student then can use the models more interactively to study and learn names of structures or functions of structures as desired.

What is therefore disclosed and claimed herein is a teaching model having luminescent painted inscriptions on the surface of the teaching model.

Such models, for example, include, but are not limited to anatomical models, health education models, life science models, biological models, science models, physical education equipment and models, physical and manipulative models.

There is a second embodiment that is a kit, said kit comprising in combination a teaching model having luminescent painted inscriptions on the surface of the teaching model and a source of black light, which may optionally contain a study guide.

A third embodiment of this invention is an educational method, wherein the method comprises providing a teaching model having luminescent painted inscriptions on the surface of the teaching model. There is provided a black light source. Thereafter, focusing the black light from the black light source on the teaching model and thereafter, reading any inscription on any component part provided by the luminescent paint.

In an alternative embodiment there is an educational method comprising providing a teaching model having luminescent painted inscriptions on the surface of the teaching model to a person undergoing the education method. There is provided a black light source to the person. Thereafter, at the discretion of the person, the person focuses the black light from the black light source on the teaching model, and thereafter, the person reads any inscription on any component part provided by the luminescent paint.

### BRIEF DESCRIPTION OF THE DRAWINGS

FIG. 1 is an illustration of a model of human forearm bones, the radius and ulna.

FIG. 2 is an illustration of the illustration of FIG. 1 with an illustrated black light shining on them.

FIG. 3 is an illustration of a flower model.

FIG. 4 is an illustration of the illustration of FIG. 3 with an illustrated black light shining on it.

FIG. 5 is an illustration of one kit combination of this invention.

### DETAILED DESCRIPTION OF THE INVENTION

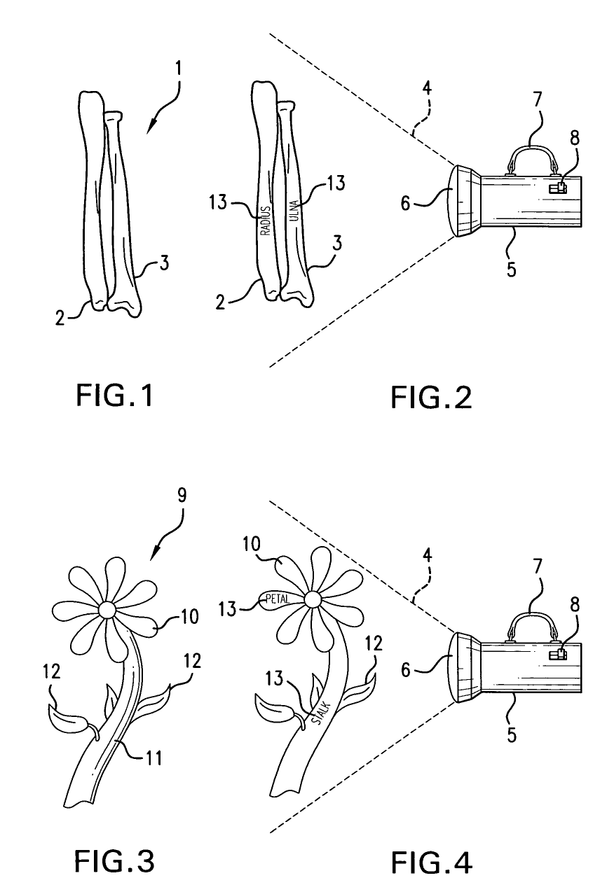

Turning now to the first embodiment of this invention, which is an instructional (educational) model that is set forth in FIG. 1. Therein is shown an illustration of the bones 1 of the forearm of a human, that is, on the left and denoted as 2 is the radius and on the right is denoted the ulna 3, which it can be observed, are not otherwise marked for description, although, they are marked with luminescent paint 13 that is not visible in natural light.

FIG. 2 shows the same illustrations that are illuminated using a black light source 4, and the black light 5 focuses on the radius 2 and the ulna 3 and these titles of the bones appear to the user of the black light.

Not critical to the invention is the form of the source of the black light 5 and for completeness, the black light source 4 shows a lens 6, a handle, 7 and an off/on button 8.

As second illustration of the invention can be found in FIGS. 3 and 4 in which in FIG. 3 there is shown an illustration of a flower 9, with petals 10, stalk 11, and leaves 12. The petals 10 and the stalk 11 are then identified in FIG. 4 by the luminescent paint 13 having the black light 5 from the black light source 4 focused on it, wherein like numerals indicate like components as in FIG. 2.

The second embodiment of this invention is a kit that is fashioned from the components of the invention, that is, a model, or models, to fit a particular educational activity, wherein the models are inscribed with the necessary titles or inscriptions of the various parts or components of the models using luminescent paints so that they can be identified with the black light source 4, and, a black light source 4.

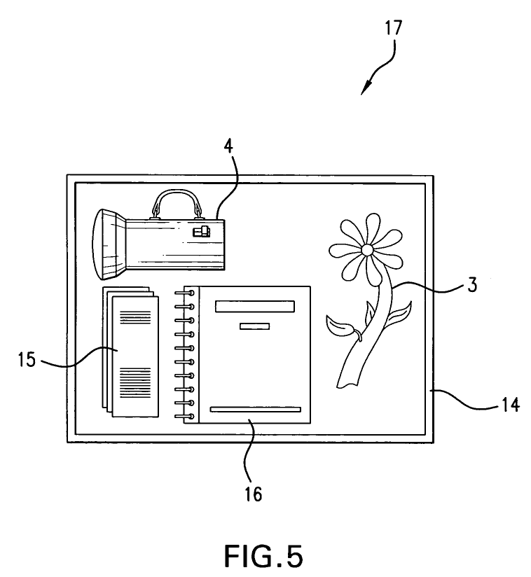

Thus in FIG. 5, there is shown a boxed kit 17, showing the box or container 14, a black light source 4, a model, for example, the flower of FIG. 3, and printed instructions 15 along with a study guide 16, wherein the instructions 15 can be incorporated into the study guide.

Turning now to a third embodiment of this invention that is an educational method, wherein the method comprises providing a teaching model having luminescent painted inscriptions on the surface of the teaching model to a student or a class of students. There is also provided to each student a black light source. Thereafter, the student can study the model and determine the intended teaching and thereafter focusing the black light from the black light source on the teaching model and thereafter, reading any inscription on any component part provided by the luminescent paint in order to determine if the student has provided the correct identification of the components parts.

In an alternative embodiment there is an educational method comprising providing a teaching model, having luminescent painted inscriptions on the surface of the teaching model, to a person undergoing the education method. There is provided a black light source to the person. Thereafter, at the discretion of the person, the person focuses the black light from the black light source on the teaching model, and thereafter, the person reads any inscription on any component part provided by the luminescent paint.

As set forth Supra, what is important to these instructional methods is that the essence of this invention is that using these methods for instructional purposes enhances the student's kinesthetic multiple intelligence with the addition of delayed visual feedback that is augmented by the use of the black light on the luminescent paint. The student is in control of the timing of the feedback, which is an important learning variable involved in achieving maximal enhancement of any learning process.

What is claimed is:

1. A teaching model having luminescent painted inscriptions on the surface of the teaching model.

2. A teaching model as claimed in claim 1 which is an educational model.

3. A teaching model as claimed in claim 2 wherein the model is an anatomical model.

4. A teaching model as claimed in claim 2 wherein the model is a health education model.

5. A teaching model as claimed in claim 2 wherein the model is a life science model.

6. A teaching model as claimed in claim 2 wherein the model is a biological model.

7. A teaching model as claimed in claim 2 wherein the model is a science model.

8. A teaching model as claimed in claim 2 wherein the model is physical education equipment.

9. A teaching model as claimed in claim 2 wherein the model is physical, manipulative model.

10. In combination, a kit, said kit comprising:
I. at least one teaching model having luminescent painted inscriptions on the surface of the teaching model;
II. at least one source of black light.

11. The combination of claim 10 wherein, in addition, there is a study guide for the teaching model.

12. An education method, said method comprising:
I. providing a teaching model having luminescent painted inscriptions on the surface of the teaching model;
II. providing a black light source;
III. focusing the black light from the black light source on the teaching model;
IV. reading any inscription on any component part provided by the luminescent paint.

13. An education method, said method comprising:
I. providing a teaching model having luminescent painted inscriptions on the surface of the teaching model to a person undergoing the education method;
II. providing a black light source to said person;
III. at the discretion of said person, said person focusing the black light from the black light source on the teaching model;
IV. said person reading any inscription on any component part provided by the luminescent paint.

14. An education method wherein more than one student comprises a study group.
